(19) United States
(12) Patent Application Publication
(10) Pub. No.: US 2019/0263072 A1
(43) Pub. Date: Aug. 29, 2019

(54) BONDING OF COMPOSITE SUBSTRATES

(71) Applicant: CYTEC INDUSTRIES INC., PRINCETON, NJ (US)

(72) Inventors: Leonard MACADAMS, Woolwich Township, NJ (US); Dalip K. KOHLI, Churchville, MD (US)

(21) Appl. No.: 16/331,299

(22) PCT Filed: Sep. 8, 2017
(86) PCT No.: PCT/US2017/050593

§ 371 Date: Mar. 7, 2019

Related U.S. Application Data
(60) Provisional application No. 62/385,365, filed on Sep. 9, 2016.

(51) Int. Cl. B29C 65/50; B29C 65/48; B29C 65/00; C09J 5/02; C09J 5/06; C09J 163/00; C09J 7/40

(52) U.S. Cl. CPC B29C 65/5057; B29C 65/4835; B29C 66/721; B29C 66/028; C09J 2205/31; C09J 5/06; C09J 163/00; C09J 7/405; C09J 5/02

(57) ABSTRACT

A method for bonding composite substrates is disclosed. A curable surface treatment layer is applied onto a curable composite substrate, followed by co-curing. After co-curing, the composite substrate is fully cured but the surface treatment layer remains partially cured. The surface treatment layer may be a resin film or a peel ply composed of resin-impregnated fabric. If a peel ply is used, the peel ply is peeled off after co-curing, leaving behind a remaining thin film of partially cured resin. A subsequent dry physical surface treatment, such as plasma, is carried out to physically modify the surface of the surface treatment layer. After dry physical surface treatment, the composite substrate is provided with a chemically-active, bondable surface, which is adhesively bonded to another composite substrate to form a covalently-bonded structure.

The instant application claims the benefit of prior U.S. Provisional Application No. 62/385,365 filed on Sep. 9, 2016, which is incorporated herein by reference.

### BRIEF DESCRIPTION OF THE DRAWINGS

FIGS. 1A-1C illustrates a method of preparing the surface of a composite substrate for adhesive bonding, according to one embodiment of the present disclosure.

FIGS. 1D and 1E illustrates the adhesive bonding of composite substrates after surface preparation.

FIG. 2A schematically illustrates a resin-rich peel ply laminated onto a fiber-reinforced composite substrate.

FIG. 2B schematically illustrates the composite substrate shown in FIG. 2A after co-curing and the removal of the peel ply.

### DETAILED DESCRIPTION

Adhesive bonding has been conventionally used as a method of joining composite structures, such as those used in the aerospace industry. Currently, adhesive bonding of composite structures is carried out predominantly by one of three ways: (1) co-curing, (2) co-bonding, and (3) secondary bonding.

“Co-curing” involves joining uncured composite parts by simultaneously curing and bonding, wherein the composite parts are being cured together with the adhesive, resulting in chemical bonding. However, it is difficult to apply this technique to the bonding of uncured prepregs to fabricate large structural parts with complex shapes. Uncured composite materials, e.g. prepregs, are tacky (i.e. sticky to the touch) and lack the rigidity necessary to be self-supporting. As such, uncured composite materials are difficult to handle. For example, it is difficult to assemble and bond uncured composite materials on tools with complex three-dimensional shapes.

“Co-bonding” involves joining a pre-cured composite part to an uncured composite part by adhesive bonding, wherein the adhesive and the uncured composite part are being cured during bonding. The pre-cured composite usually requires an additional surface preparation step prior to adhesive bonding.

“Secondary bonding” is the joining together of pre-cured composite parts by adhesive bonding, wherein only the adhesive is being cured. This bonding method typically requires surface preparation of each previously cured composite part at the bonding surfaces.

Proper surface treatment for co-bonding and secondary bonding is a prerequisite to achieve the highest level of bond line integrity in adhesively bonded structures. Bond line integrity, generally, refers to the overall quality and robustness of the bonded interface. Conventional co-bonding and secondary bonding processes typically include a surface treatment of the composite structures pursuant to the manufacturer's specifications prior to adhesive bonding. Surface treatments include, but are not limited to grit blasting, sanding, peel ply, priming, etc. These surface treatment methods improve adhesion predominantly by mechanical roughening of the surface. The roughened surface allows for better adhesion due to mechanical interlocking at the bonding interface. Unlike co-cure bonding, no chemical bonds are formed at the adhesive-adherend interface in co-bond and secondary bonded joints. Without formation of chemical bonds, bondline integrity is difficult to assess and the entire bonding process is less robust making reliability difficult.

For certification reasons, aerospace structural components and, in particular, composite parts, are joined by mechanical fastening in which rivets, fasteners, screws, etc. are used. The use of mechanical fasteners ensures reliability; however, it also damages the underlying part and reduces performance. For instance, hot-wet open hole compression performance typically drops by more than 30%. Adhesively bonded parts exhibit significant advantages over parts joined by mechanical fasteners including: lighter weight, reduced stress concentrations, durability, lower part count, etc. Despite these benefits, the use of adhesive bonding is limited due, in part, to the difficulty in assessing bond line integrity. Currently, no non-destructive method exists to measure the bond strength of joined parts. The only way to measure the strength of an adhesively bonded joint is to find the ultimate strength, which is obtained by breaking the bond. For obvious reasons, this type of destructive testing is not practical in an industrial manufacturing environment such as the assembly of an aircraft. Moreover, proof testing a large number of specimens to determine the average load capacity of an adhesive does not guarantee that each and every bonded structure will have the expected bond strength.

In order to improve the reliability in the bonding process several techniques have been implemented in the aerospace industry. For instance, plasma treatment technologies, which utilize ionized gases, are used to impact key surface properties, such as surface energy, to facilitate bonding. While many distinct plasma processes exist such as low pressure plasma, high pressure plasma, corona treatment, and atmospheric pressure plasma, they all effectively aid bonding by cleaning the surface of contaminants and by increasing surface roughness. Additionally, plasma treatment, depending on the gases used, may act to functionalize the surface of a composite material; however, said functional groups created through plasma treatment are not chemically reactive with most thermosetting-based adhesives used in the industry.

Most physical surface treatments such as plasma and laser ablation require extensive fine-tuning of process variables (time, intensity, distance, etc.) to optimize the surface conditions. The process variables are dependent on the substrate being treated and can vary greatly, adding complexity to the treatment process. Thus, it would be advantageous to eliminate the variability that is present by providing a consistent bonding surface whereby the same processing variables will be used regardless of the substrate being bonded.

The present disclosure introduces a surface treatment method for increasing the adhesion between composite structures in a bonding process. This surface treatment method is designed to increase the reliability of the adhesion between composite substrates such that there is a known adhesion mechanism in place that can prevent defects in the bondline.

Disclosed herein is a bonding method for bonding two composite substrates. This bonding method includes:

(a) providing a first composite substrate comprising reinforcing fibers impregnated with a curable matrix resin;

(b) applying a resin-rich peel ply onto a surface of the first composite substrate;

(c) co-curing the first composite substrate and the peel ply until the first composite substrate is fully cured but the resin in the peel ply remains partially cured;

(d) removing the peel ply from the first composite substrate's surface, leaving a thin film of partially cured peel ply resin remaining on the first composite substrate's surface;

(e) physically modifying the surface of the remaining film of partially cured second matrix resin using a dry physical surface treatment method, wherein the modified surface of the remaining film comprises chemical functional groups thereon;

(f) joining the cured first composite substrate to a second composite substrate with a curable adhesive film in between, wherein the modified surface on the first composite substrate is in contact with the curable adhesive film; and

(g) curing the adhesive film between the joined composite substrates to form a covalently bonded structure.

The resin-rich peel ply applied prior to co-curing at (c) is composed of a woven fabric impregnated with a resin matrix that is different from the resin matrix of the first composite substrate. The peel ply is designed such that it can be co-cured with the composite substrate but remains partially cured when the composite substrate is fully cured. Upon removal of the peel ply after co-curing, a thin, continuous film of peel ply resin remains on the cured surface of the fully cured composite substrate. The remaining partially-cured peel ply resin film provides a surface that has chemically reactive functional groups capable of chemically reacting with the curable adhesive film in the subsequent bonding step. Moreover, the remaining peel ply resin film functions as a semi-sacrificial surface film in the dry physical surface treatment, and consequently, the conventional process of optimizing the process variables associated with the dry physical surface treatment such as plasma treatment and laser ablation is eliminated.

In an alternative embodiment, the resin-rich peel ply in the bonding method described previously is replaced with a curable resin film, which does not contain any fabric or reinforcement fibers embedded therein (referred hereafter as “surface resin film”). In this embodiment, the step of removing the peel ply (step (d)) is not needed, but the remaining steps are the same. The surface resin film is formulated so that it cures more slowly than the matrix resin of the composite substrate. As a result, when the composite substrate is fully cured, the surface resin film is only partially cured and the cured composite substrate is provided with a bondable surface having chemically-active functional groups. The partially-cured surface resin film is subjected to the dry physical surface treatment as described previously, resulting in a bondable surface with chemical functional groups.

It has been found that, without the intervening physical modifying step (e), a complete and reliable covalent bonding can be achieved, however, if the bonding is performed in an unsanitary environment in which contamination of the bonded structure is possible, then the resulting bonded interface between the substrates has the potential to be compromised. Also, it has been discovered that the combination of physical surface treatment and application of a surface resin film containing chemical reactive functional groups with or without the use of peel ply results in a synergistic balance of properties unattainable using either treatment alone.

The dry physical surface treatment of the present disclosure abrades, roughens, or otherwise physically modifies the surface to create a bondable surface that is substantially free of contaminants but still contains chemical functional groups for covalent bonding. The dry physical surface treatment excludes wet chemical treatments using liquids such as wet etching. Physical methods of physically modifying the surface include, but are not limited to, plasma treatment, laser ablation, irradiation using ion beams, and sand blasting. Plasma treatment may be carried out by exposing the surface to a plasma generated from oxygen gas, air, or an inert gas such as nitrogen or argon, or combination of gases.

The term “plasma” as used herein refers to the state of partially or completely ionized gas. A plasma consists of charged ions (positive or negative), negatively charged electrons, neutral species, radicals and excited species. As known in the art, a plasma may be generated for example by a power source such as an alternating current (AC), a direct current (DC) low frequency (LF), audio frequency (AF), radio frequency (RF) and microwave power source. Plasma treatment may include positioning the substrate being treated in the afterglow region of a gas plasma having a main region and an afterglow region. Plasma treatment conditions may include power levels from about 1 watt to about 1000 watts, including about 5 watts to about 500 watts. Exposure speed may be 10 mm/s to 100 mm/s, including 30 mm/s to 50 mm/s.

The use of peel ply and the surface resin film provides the desired benefit of minimizing bonding variables by creating a consistent, bondable surface regardless of the underlying substrate being joined.

The novel surface preparation method disclosed herein enables the creation of a chemically-active composite surface that is chemically bondable to another substrate via the use of a resin adhesive. One advantage of this bonding method is that a chemical bond is created between the composite surface and the adhesive, resulting in a stronger bond between composite substrates. Another advantage of this process is that it minimizes the effect of contamination on the bonding surfaces of the composite substrates.

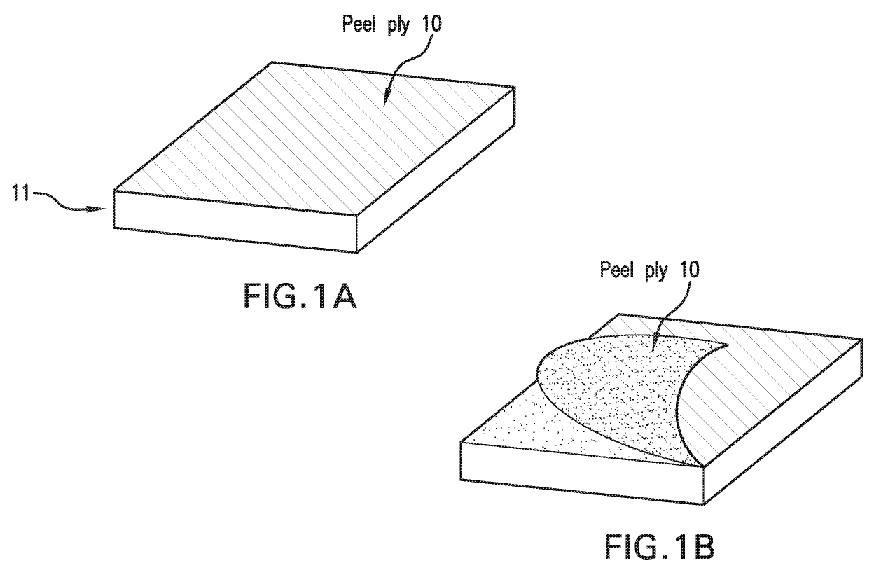

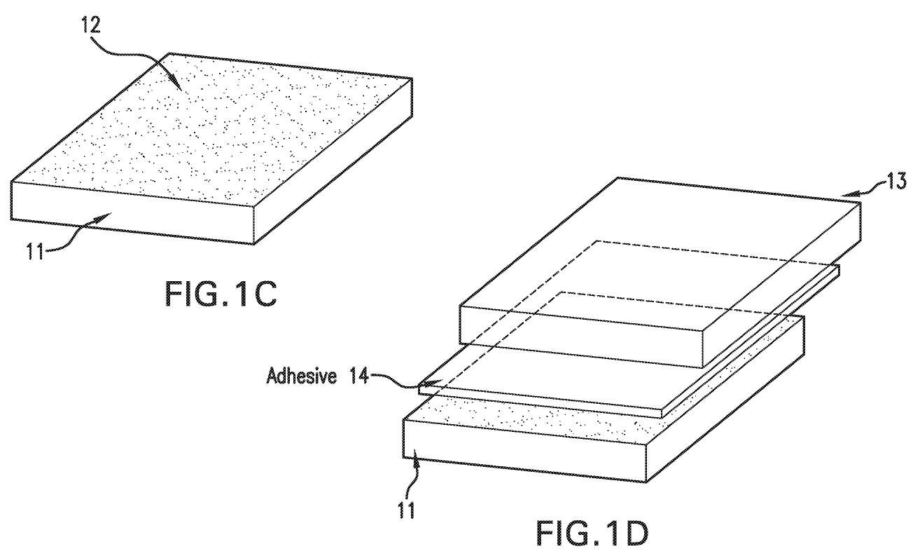

FIGS. 1A-1C illustrates how a resin-rich peel ply is used to create a bondable surface with chemically-active functional groups. Referring to FIG. 1A, a curable peel ply 10 is first laminated onto an outermost surface of an uncured or curable composite substrate 11. The uncured/curable composite substrate is composed of reinforcement fibers infused or impregnated with an uncured or curable matrix resin, which contain one or more thermosetting resins. The curable peel ply 10 is composed of a woven fabric infused or impregnated with a curable matrix resin that is different from the uncured/curable matrix resin of the composite substrate. The matrix resin of the peel ply 10 also contains one or more thermosetting resins; however, it is formulated so that the peel ply resin is only partially cured when the composite substrate 11 is fully cured under the same curing conditions. Next, co-curing of the peel ply 10 and the composite substrate 11 is carried out by heating at elevated temperature(s) for a pre-determined time period until the composite substrate 11 is fully cured, but the peel ply 10 is only partially cured. Co-curing of the peel ply 10 and composite substrate 11 may be carried out at a temperature ranging from room temperature to 375° F. (191° C.) for 1 hour to 12 hours at pressures ranging from 0 psi to 80 psi (0 MPa-0.55 MPa). Moreover, co-curing may be achieved in a pressurized autoclave or by an out-of-autoclave process in which no external pressure is applied.

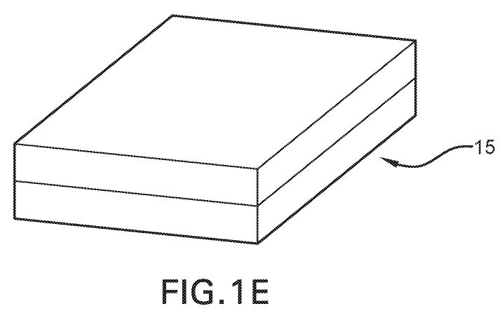

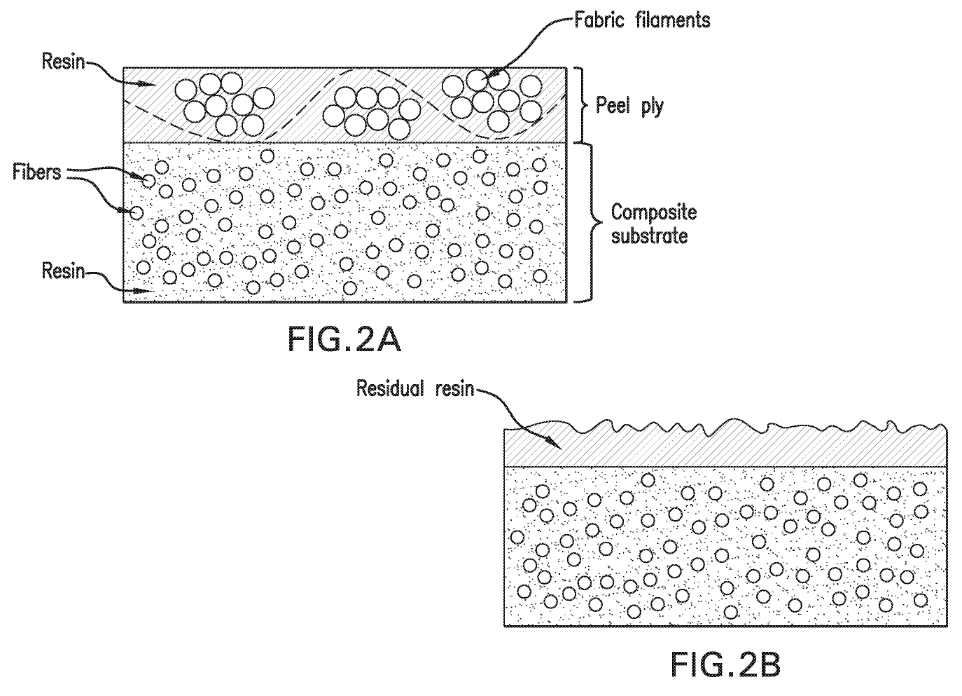

As a result of co-curing, the peel ply matrix resin intermingles and reacts with the composite matrix resin. The rheology and cure kinetics of the peel ply resin are controlled to obtain the desired amount of intermingling between the peel ply resin matrix and the resin matrix of the composite substrate to maximize the co-curing of the resin matrices, thereby ensuring that a sufficient amount of peel ply resin remains on the composite's surface following co-curing and removal of peely ply fabric. After co-curing, the majority of the peel ply (including the fabric therein) is peeled off (FIG. 1B) leaving behind a thin film 12 of partially-cured peel ply resin (FIG. 1C). FIGS. 2A and 2B provide another illustration of the peel ply on the composite substrate prior to peeling and after peeling, respectively. The remaining thin film of partially-cured peel ply resin is then subjected to a dry physical surface treatment, for example, plasma treatment. In one embodiment, the plasma treatment is carried out by exposing the cured composite substrate with the partially cured peel ply resin film thereon to a plasma generated from air. This plasma treatment may be carried out at or above atmospheric pressure and the air may be heated to a temperature within the range of 22° C. to 100° C.

Following the dry physical surface treatment, the cured composite substrate 11 is provided with a bondable surface 12 that can be joined to another composite substrate 13 with a curable resin adhesive film 14 sandwiched in between the substrates as shown in FIG. 1D. The curable resin adhesive film 14 is in an uncured or partially cured state and possesses chemical functional groups that are capable of reacting with the chemically-active functional groups on the bondable surface 12. During a subsequent heat treatment to affect bonding, these functional groups react with each other to form chemical or covalent bonds.

The composite substrate 13 may be a cured composite substrate that has been subjected to the same combination of peel ply surface preparation and physical surface treatment (e.g. plasma treatment) as described for composite substrate 11 so as to form a counterpart bondable surface with chemically-active functional groups. The joined composite substrates 11 and 13 are then subjected heat treatment at elevated temperature(s) to cure the adhesive, resulting in a covalently bonded structure 15 (FIG. 1E)—this is referred to as secondary bonding. The adhesive film 14 may be applied to either or both of the bondable surfaces of composite substrates 11 and 13.

Alternatively, the bondable surface of the composite substrate 13 may be prepared by another surface treatment such as sand blasting, grit blasting, dry peel ply surface preparation, etc. “Dry peel ply” is a dry, woven fabric (without resin), usually made out of nylon, glass, or polyester, which is applied to the bonding surface of the curable composite substrate before curing. After curing, the dry peel ply is removed from the cured composite substrate to reveal a textured bonding surface.

In another embodiment, the composite substrate 13 is in an uncured state when it is joined to the cured composite substrate 11. In such case, the uncured composite substrate 13 and the curable adhesive film 14 are cured simultaneously in a subsequent heating step—this is referred to as co-bonding.

During co-bonding or secondary bonding of the composite substrates according the methods disclosed herein, chemical or covalent bonds are formed between the reactive moieties present in the resin adhesive and the chemically-reactive functional groups on the bondable surface of the composite substrate derived from the resin-rich peel ply or surface resin film. As a result, the covalently bonded structure has essentially no adhesive-composite interface. The presence of the chemically-active functional groups on the bondable surface described herein optimizes the subsequent bonding process by increasing the bond strength between the bonded substrates and improving bonding reliability. Furthermore, the covalently bonded structure is more resistant to contamination than bonded structures prepared by conventional co-bonding or secondary bonding processes.

The terms “cure” and “curing” as used herein encompass polymerizing and/or cross-linking of resin precursors or monomers brought about by mixing of components, heating at elevated temperatures, or exposure to ultraviolet light and radiation. “Fully cured” as used herein refers to 100% degree of cure. “Partially cured” as used herein refers to less than 100% degree of cure.

### Peel Ply and Surface Resin Film

The peel ply resin and the surface resin film may contain one or more curing agents (or curatives), or may be void of any curing agent. In embodiments in which the peel ply resin or surface resin film contains a curing agent, the degree of cure of the partially cured peel ply after co-curing with the composite substrate may be within the range of 10%-75% of full cure, e.g. 25%-75% or 25%-50%. In embodiments in which the peel ply resin or the surface resin film does not contain any curing agent, the peel ply resin or surface resin film is mostly uncured after co-curing with the composite substrate except at the interface.

The degree of cure of a thermosetting resin system can be determined by Differential Scanning Calorimetry (DSC). A thermosetting resin system undergoes an irreversible chemical reaction during curing. As the components in the resin system cure, heat is evolved by the resin, which is monitored by the DSC instrument. The heat of cure may be used to determine the percent cure of the resin material. As an example, the following simple calculation can provide this information:

% Cure=[ΔH_{uncured}−ΔH_{cured}]/[ΔH_{uncured}]×100%.

The resin-rich peel ply of the present disclosure is composed of a fabric impregnated with a curable matrix resin, and has a resin content of at least 20% by weight based on the total weight of the peel ply, depending on the specific type of fabric being impregnated. In certain embodiments, the resin content is within the range of 20%-80% by weight, including 20%-50%. In one embodiment, the resin-rich peel ply of the present disclosure contains, based on the total weight of the peel ply: 20 wt %-80 wt % of thermosetting matrix resin, 2 wt %-20 wt % curing agent(s), and 5 wt %-40 wt % of additional modifiers or filler additives. A suitable peel ply for the purposes herein is that described in U.S. Pat. No. 9,473,459.

Each of the peel ply resin and the surface resin film is formed from a curable resin composition containing: one or more thermosetting resins; at least one curing agent; and optionally, additives, modifiers, and fillers. According to an alternative embodiment, the resin composition of the peel ply and surface resin film contains one or more thermosetting resins, but does not include any curing agent.

Suitable thermosetting resins include, but are not limited to, epoxies, phenolics, phenols, cyanate esters, bismaleimides, benzoxazines, polybenzoxazines, polybenzoxazones, combinations thereof and precursors thereof.

Particularly suitable are multifunctional epoxy resins (or polyepoxides) having a plurality of epoxide functional groups per molecule. The polyepoxides may be saturated, unsaturated, cyclic, or acyclic, aliphatic, aromatic, or heterocyclic polyepoxide compounds. Examples of suitable polyepoxides include the polyglycidyl ethers, which are prepared by reaction of epichlorohydrin or epibromohydrin with a polyphenol in the presence of alkali. Suitable polyphenols therefore are, for example, resorcinol, pyrocatechol, hydroquinone, bisphenol A (bis(4-hydroxyphenyl)-2,2-propane), bisphenol F (bis(4-hydroxyphenyl)-methane), fluorine 4,4′-dihydroxy benzophenone, bisphenol Z (4,4′-cyclohexylidene-bisphenol) and 1,5-hyroxynaphthalene. Other suitable polyphenols as the basis for the polyglycidyl ethers are the known condensation products of phenol and formaldehyde or acetaldehyde of the novolac resin-type.

Examples of suitable epoxy resins include diglycidyl ethers of bisphenol A or bisphenol F, e.g. EPON™ 828 (liquid epoxy resin), D.E.R. 331, D.E.R. 661 (solid epoxy resins) available from Dow Chemical Co.; triglycidyl ethers of aminophenol, e.g. ARALDITE® MY 0510, MY 0500, MY 0600, MY 0610 from Huntsman Corp. Additional examples include phenol-based novolac epoxy resins, commercially available as DEN 428, DEN 431, DEN 438, DEN 439, and DEN 485 from Dow Chemical Co; cresol-based novolac epoxy resins commercially available as ECN 1235, ECN 1273, and ECN 1299 from Ciba-Geigy Corp.; hydrocarbon novolac epoxy resins commercially available as TACTIX® 71756, TACTIX®556, and TACTIX®756 from Huntsman Corp.

The resin composition of the peel ply or surface resin film is preferably a one-part system that is to be cured at an elevated temperature, and thus, it contains one or more curing agents. Such curing agents are capable of accomplishing crosslinking or curing of selective components of the peel ply resin composition when heated to a temperature above room temperature. For the purpose discussed herein, the amount of curing agents is selected so that there is preferably about 0.1 to about 1 equivalent of curing agent per one equivalent of epoxy molecule, more preferably 0.1-0.5. The exact ratio of curing agent to epoxy is selected such that the optimum number of chemically-active surface functional groups is retained following co-curing with the composite substrate. Suitable curing agents for the peel ply resin may include, but are not limited to, aliphatic and aromatic amines, boron trifluoride complexes, guanidines, dicyandiamide, bisureas (e.g. 2,4-Toluene bis-(dimethyl urea), 4,4′-Methylene bis-(phenyl dimethylurea)), and diaminodiphenylsulfone, (e.g. 4,4′-diaminodiphenylsulfone or 4,4′-DDS). One or more curing agents may be used and the total amount of curing agent(s) may be within the range of 2%-20% by weight based on the total weight of the resin composition.

Inorganic fillers in particulate form (e.g. powder) may also be added to the resin composition as a rheology modifying component to control the flow of the resinous composition and to prevent agglomeration therein. Suitable inorganic fillers include, but are not limited to, fumed silica, talc, mica, calcium carbonate, alumina, ground or precipitated chalks, quartz powder, zinc oxide, calcium oxide, and titanium dioxide. If present, the amount of fillers in the peel ply resin compositions may be from 0.5% to 40% by weight, or 1-10% by weight, or 1-5% by weight, based on the total weight of the resin composition.

In one embodiment, the ratio of thermosetting resin(s) and curing agent(s) in the composition of the peel ply resin is adjusted so that the composition contains a deficiency in the amount of curing agent(s) that is necessary for reacting with 100% of the thermosetting resin(s), and consequently, due to this deficiency, there will be unreacted or non-crosslinked functional groups from thermosetting resin material at the end of a pre-determined curing cycle. For example, if an X amount of a curing agent is needed to achieve 100% degree of cure in a predetermined curing cycle, less than X amount, e.g. up to 80% X, preferably 25%-50% X, may be used in the peel ply resin composition to achieve partial curing. The thermosetting resin material contains unreacted/noncrosslinked functional groups, which is the source of chemically-active functional groups for the bondable surface discussed above.

In another embodiment, the curing agents (or curatives) in the peel ply resin or the surface resin film are preferentially selected to allow for a slower cure rate than that of the composite substrate's matrix resin. The curatives may be selected from well-known curatives with reactivities that are well established. For instance, curatives for epoxy resins in order of increasing curing rate are generally classified as: polymercaptan<polyamide<aliphatic polyamine<aromatic polyamine derivatives<tertiary amine boron trifluoride complex<acid anhydride<imidazole<aromatic polyamine<cyanoguanadine<phenol novolac. This list is only a guide and overlap within classifications exists. Curatives in the peel ply resin and surface resin film are generally selected from groups that are listed towards the higher end of the reaction order, whereas the composite substrate's curatives may be generally selected from groups towards the beginning of the reaction order.

In the embodiments that use resin-rich peel ply for surface treatment, the peel ply may be formed by coating the resin composition described above onto the woven fabric so as to completely impregnate the yarns in the fabric using conventional solvent or hot-melt coating processes. The wet peel ply is then allowed to dry, if needed, to reduce the volatile content, preferably, to less than 2% by weight. Drying may be done by air drying at room temperature overnight followed by oven drying at 140° F.-170° F., or by oven drying at elevated temperature as necessary to reduce the drying time. Subsequently, the dried resin-rich peel ply may be protected by applying removable release papers or synthetic films (e.g. polyester films) on opposite sides. Such release papers or synthetic films are to be removed prior to using the peel ply for surface bonding.

In the embodiments that use surface resin film for surface treatment, the resin film may be formed by coating a resin composition onto a removable carrier, e.g. release paper, using conventional film coating processes. The wet resin film is then allowed to dry. Subsequently, the resin film is placed onto a surface of a composite substrate, and the carrier is removed.

### Composite Substrates

Composite substrates in the context of the present disclosure refer to fiber-reinforced polymeric composites, including prepregs or prepreg layups (such as those used for making aerospace composite structures). The term “prepreg” as used herein refers to a layer of fibrous material (e.g., in the form of unidirectional fiber tows, nonwoven or woven fabric ply) that has been impregnated with a curable matrix resin. The matrix resin in the composite substrates may be in an uncured or partially cured state. The fiber reinforcement material may be in the form of a woven or nonwoven fabric ply, or unidirectional tape. “Unidirectional tape” refers to a layer of reinforcement fibers, which are aligned in the same direction. The term “prepreg layup” as used herein refers to a plurality of prepreg plies that have been laid up in a stacking arrangement.

The layup of prepreg plies may be done manually or by an automated process such as Automated Tape Laying (ATL). As examples, the number of prepreg plies may be 2-100 plies, or 10-50 plies. The prepreg plies within the layup may be positioned in a selected orientation with respect to one another. For example, prepreg layups may comprise prepreg plies having unidirectional fiber architectures, with the fibers oriented at a selected angle θ, e.g. 0°, 45°, or 90°, with respect to the largest dimension of the layup, such as the length. It should be further understood that, in certain embodiments, the prepregs may have any combination of fiber architectures, such as unidirectionally aligned fibers, multi-directional fibers, and woven fabrics.

Prepregs may be manufactured by infusing or impregnating continuous fibers or woven fabric with a matrix resin system, creating a pliable and tacky sheet of material. This is often referred to as a prepregging process. The precise specification of the fibers, their orientation and the formulation of the resin matrix can be specified to achieve the optimum performance for the intended use of the prepregs. The volume of fibers per square meter can also be specified according to requirements.

In a typical prepreg manufacturing process, the reinforcing fibers are impregnated with the matrix resin in a controlled fashion and then frozen in order to inhibit polymerization of the resin. The frozen prepregs are then shipped and stored in the frozen condition until needed. When manufacturing composite parts from prepregs, the prepregs are thawed to room temperature, cut to size, and assembled on a molding tool. Once in place, the prepregs are consolidated and cured under pressure to achieve the required fiber volume fraction with a minimum of voids.

The term “impregnate” refers to the introduction of a curable matrix resin material to reinforcement fibers so as to partially or fully encapsulate the fibers with the resin. The matrix resin for making prepregs may take the form of resin films or liquids. Moreover, the matrix resin is in an uncured or partially cured state prior to bonding. Impregnation may be facilitated by the application heat and/or pressure.

As an example, the impregnating method may include:
(1) continuously moving fibers through a (heated) bath of molten impregnating matrix resin composition to fully or substantially fully wet out the fibers; or
(2) pressing top and bottom resin films against continuous, unidirectional fibers arranged in parallel or a fabric ply.

The reinforcement fibers in the composite substrates (e.g. prepregs) may take the form of chopped fibers, continuous fibers, filaments, tows, bundles, sheets, plies, and combinations thereof. Continuous fibers may further adopt any of unidirectional (aligned in one direction), multi-directional (aligned in different directions), non-woven, woven, knitted, stitched, wound, and braided configurations, as well as swirl mat, felt mat, and chopped mat structures. Woven fiber structures may comprise a plurality of woven tows, each tow composed of a plurality of filaments, e.g., thousands of filaments. In further embodiments, the tows may be held in position by cross-tow stitches, weft-insertion knitting stitches, or a small amount of resin or polymeric binder, such as a thermoplastic polymer.

The fiber materials include, but are not limited to, glass (including Electrical or E-glass), carbon, graphite, aramid, polyamide, high-modulus polyethylene (PE), polyester, poly-p-phenylene-benzoxazole (PBO), boron, quartz, basalt, ceramic, and combinations thereof.

For the fabrication of high-strength composite materials, such as those for aerospace and automative applications, it is preferred that the reinforcing fibers have a tensile strength of greater than 3500 MPa (per ASTM D4018 test method).

Generally, the matrix resin of the composite substrates is similar to that of the peel ply resin. It contains one or more thermosetting resins and curing agents as the major components in combination with minor amounts of additives such as catalysts, co-monomers, rheology control agents, tackifiers, rheology modifiers, inorganic or organic fillers, thermoplastic or elastomeric toughening agents, stabilizers, inhibitors, pigments/dyes, flame retardants, reactive diluents, and other additives well known to those skilled in the art for modifying the properties of the resin matrix before or after curing.

The thermosetting resins described above in reference to the peel ply's matrix resin and the surface resin film are also suitable for the matrix resin of the composite substrates. Suitable epoxy resins for the matrix resin of the composite substrates include polyglycidyl derivatives of aromatic diamine, aromatic mono primary amines, aminophenols, polyhydric phenols, polyhydric alcohols, polycarboxylic acids. Examples of suitable epoxy resins include polyglycidyl ethers of the bisphenols such as bisphenol A, bisphenol F, bisphenol S and bisphenol K; and polyglycidyl ethers of cresol- and phenol-based novolac epoxy resins.

The curing agent for thermosetting resins is suitably selected from known curing agents, for example, amines (including primary and secondary amines, aliphatic and aromatic amines), amides, anhydrides (including polycarboxylic anhydrides), guanidines (including substituted guanidines), ureas (including substituted ureas), melamine resins, guanamine, and mixtures thereof.

The toughening agents may include thermoplastic and elastomeric polymers, and polymeric particles such as core-shell rubber particles, polyimide particles, polyamide particles, etc.

Inorganic fillers may include fumed silica quartz powder, alumina, platy fillers such as mica, talc or clay (e.g., kaolin).

### Adhesive

The adhesive for bonding composite substrates is a curable composition suitable for co-curing with uncured or curable composite substrates. The curable adhesive composition may comprise one or more thermosetting resins, curing agent(s) and/or catalyst(s), and optionally, toughening agents, filler materials, flow control agents, dyes, etc. The thermosetting resins include, but are not limited to, epoxy, unsaturated polyester resin, bismaleimide, polyimide, cyanate ester, phenolic, etc.

The epoxy resins that are suitable for the curable adhesive composition include multifunctional epoxy resins having a plurality of epoxy groups per molecule, such as those disclosed for the matrix resin of the peel ply, the surface resin film and the composite substrates.

The curing agents may include, for example, amines (including primary and secondary amines, aliphatic and aromatic amines), amides, anhydrides, guanidines (including substituted guanidines), ureas (including substituted ureas), melamine resins, guanamine, and mixtures thereof. Particularly suitable are latent amine-based curing agents, which can be activated at a temperature greater than 160° F. (71° C.), or greater than 200° F. (93° C.), e.g. 350° F. (176.7° C.). Examples of suitable latent amine-based curing agents include dicyandiamide (DICY), guanamine, guanidine, aminoguanidine, and derivatives thereof.

A curing accelerator may be used in conjunction with the latent amine-based curing agent to promote the curing reaction between the epoxy resins and the amine-based curing agent. Suitable curing accelerators may include alkyl and aryl substituted ureas (including aromatic or alicyclic dimethyl urea); bisureas based on toluenediamine or methylene dianiline. An example of bisurea is 2,4-toluene bis(dimethyl urea). As an example, dicyandiamide may be used in combination with a substituted bisurea as a curing accelerator.

Toughening agents may include thermoplastic or elastomeric polymers, and polymeric particles such as core-shell rubber (CSR) particles. Suitable thermoplastic polymers include polyarylsulphones with or without reactive functional groups. An example of polyarylsulphone with functional groups include, e.g. polyethersulfone-polyetherethersulfone (PES-PEES) copolymer with terminal amine functional groups. Suitable elastomeric polymers include carboxyl-terminated butadiene nitrile polymer (CTBN) and amine-terminated butadiene acrylonitrile (ATBN) elastomer. Examples of CSR particles include those commercially available under the trademark Kane Ace®, such as MX 120, MX 125, and MX 156 (all containing 25 wt. % CSR particles dispersed in liquid Bisphenol A epoxy).

Inorganic fillers may be in particulate form, e.g. powder, flakes, and may include fumed silica quartz powder, alumina, mica, talc and clay (e.g., kaolin).

### EXAMPLE

As an example, a composite laminate may be fabricated by laying up 10 plies of CYCOM 5320-1 prepreg, which is composed of unidirectional carbon fibers impregnated with a toughened epoxy resin (available from Cytec Solvay Group), in a unidirectional fashion (or 0 degree orientation) and one ply of a resin-rich peel material as the topmost layer. The resin-rich peel ply material is composed of a woven glass fabric embedded in an epoxy-based resin as described in U.S. Pat. No. 9,473,459. The entire assembly can be cured in an autoclave at 350° F. (176.7° C.) for two hours to complete the curing and achieve full consolidation of the composite laminate. Following cure, the peel ply fabric is removed to create a chemically active surface with a high degree of micro-roughness on the cured composite laminate. The chemically active surface is then treated with atmospheric pressure plasma. Plasma surface treatment may be carried out using Plasmatreat FG5001 Plasma Generator equipped with a Janome JR 3503 robot and 22826 plasma nozzle head. The treatment distance may be set at 5 mm and the displacement speed is 50 mm/s. Following plasma treatment, the surface treated composite laminate is bonded to a similarly prepared cured composite laminate using FM 309-1 film adhesive (an epoxy-based adhesive available from Cytec Solvay Group).

1. A bonding method comprising:
(a) providing a first composite substrate comprising reinforcing fibers impregnated with a curable first matrix resin;
(b) applying a resin-rich peel ply onto a surface of the first composite substrate, said peel ply comprising a woven fabric impregnated with a curable second matrix resin different from the first matrix resin;
(c) co-curing the first composite substrate and the peel ply until the first composite substrate is fully cured but the second matrix resin in the peel ply remains partially cured;
(d) removing the peel ply from the first composite substrate's surface, leaving a thin film of partially cured second matrix resin remaining on the first composite substrate's surface;
(e) physically modifying the surface of the remaining film of partially cured second matrix resin using a dry physical surface treatment method, whereby the modified surface of the remaining film is a bondable surface with chemical functional groups;
(f) joining the cured first composite substrate to a second composite substrate with a curable adhesive film in between the composite substrates, wherein the modified surface on the first composite substrate is in contact with the curable adhesive film and the curable adhesive film comprises chemical functional groups capable of reacting with the chemical functional groups of the modified surface; and
(g) curing the adhesive film between the joined composite substrates to form a covalently bonded structure.

2. The bonding method of claim 1, wherein the dry physical surface treatment method at (e) is selected from plasma treatment, laser ablation, irradiation using ion beam, and sand blasting.

3. The bonding method of claim 1, wherein the dry physical surface treatment method at (e) is a plasma treatment using a plasma generated from a gas selected from: oxygen, air, inert gas, and combination thereof.

4. The bonding method of claim 1, wherein the dry physical surface treatment method at (e) is plasma treatment using a plasma generated from air.

5. The bonding method according to claim 1, wherein the second composite substrate being joined to the cured first composite substrate at (f) is a cured composite substrate comprising reinforcement fibers embedded in a cured matrix resin.

6. The bonding method of claim 5, wherein at (f), the cured second composite substrate comprises a second bondable surface having chemical functional groups, and said second bondable surface is in contact with the curable adhesive film.

7. The bonding method of claim 6, wherein the second bondable surface on the cured second composite substrate is prepared by:
(i) providing a second composite substrate comprising reinforcing fibers impregnated with a curable third matrix resin;
(ii) applying a second resin-rich peel ply onto a surface of the second composite substrate, said peel ply comprising a woven fabric impregnated with a curable fourth matrix resin different from the third matrix resin;
(iii) co-curing the second composite substrate and the second peel ply until the second composite substrate is fully cured but the fourth matrix resin in the peel ply remains partially cured;
(iv) removing the second peel ply from the second composite substrate's surface, leaving a thin film of partially-cured fourth matrix resin remaining on the cured second composite substrate's surface; and
(v) physically modifying the surface of the remaining film of partially-cured fourth matrix resin using a dry physical surface treatment method.

8. The bonding method according to claim 1, wherein the second composite substrate being joined to the cured first composite substrate at (f) is uncured or partially cured, and at (g), the adhesive film and the second composite substrate are cured simultaneously.

9. The bonding method according to claim 1, wherein the second matrix resin comprises one or more multifunctional epoxy resins, and after physical modification at (e), the chemical functional groups on the bondable surface of the first composite substrate comprise epoxy functional groups.

10. The bonding method according to claim 1, wherein the curable adhesive film comprises at least one multifunctional epoxy resin and at least one aliphatic or cyclic amine compound capable of reacting with the multifunctional epoxy resin.

11. The bonding method according to claim 1, wherein the second matrix resin comprises at least one thermosetting resin and at least one curing agent for crosslinking the thermosetting resin, and the molar ratio of thermosetting resin to curing agent is such that there is a deficiency in the amount of curing agent that is necessary for reacting with 100% of the thermosetting resin, and consequently, there is unreacted, non-crosslinked thermosetting resin in the peel ply after co-curing at (c).

12. The bonding method according to claim 1, wherein the second matrix resin is formulated to cure at a slower rate than the first matrix resin.

13. The bonding method according to claim 1, wherein the first and second matrix resins comprise different curing agents that are selected to affect curing at different rates.

14. A bonding method comprising:
(a) providing a first composite substrate comprising reinforcing fibers impregnated with a curable, first matrix resin;
(b) applying a curable resin film onto a surface of the first composite substrate, wherein said curable resin film does not comprise any reinforcement fibers;
(c) co-curing the first composite substrate and the resin film until the first composite substrate is fully cured but the resin film remains partially cured;
(d) physically modifying the surface of the partially cured resin film using a dry physical surface treatment method, whereby the modified surface of the partially cured resin film is a bondable surface with chemical functional groups;
(f) joining the cured first composite substrate to a second composite substrate with a curable adhesive film in between the composite substrates, wherein the modified surface of the partially cured resin film is in contact with the curable adhesive film and the curable adhesive film comprises chemical functional groups capable of reacting with the chemical functional groups of the modified surface; and
(g) curing the adhesive film between the joined composite substrates to form a covalently bonded structure.

15. The bonding method of claim 14, wherein the dry physical surface treatment method at (d) is selected from plasma treatment, laser ablation, irradiation using ion beam, and sand blasting.

16. The bonding method of claim 15, wherein the dry physical surface treatment method at (d) is plasma treatment using a plasma generated from a gas selected from oxygen, air, inert gas, and combination thereof.

17. The bonding method of claim 16, wherein the dry physical surface treatment method at (d) is a plasma treatment using a plasma generated from air.

18. The bonding method according to claim 1, wherein the second matrix resin comprises at least one thermosetting resin and at least one curing agent for crosslinking the thermosetting resin, and the molar ratio of thermosetting resin to curing agent is such that there is a deficiency in the amount of curing agent that is necessary for reacting with 100% of the thermosetting resin, and consequently, there is unreacted, non-crosslinked thermosetting resin in the resin film after co-curing at step (c).

19. The bonding method according to claim 1, wherein the second matrix resin is formulated to cure at a slower rate than the first matrix resin.

20. The bonding method according to claim 1, wherein the first and second matrix resins comprise different curing agents that are selected to affect curing at different rates.
